(19) United States
(12) Patent Application Publication
(10) Pub. No.: US 2010/0257771 A1
(43) Pub. Date: Oct. 14, 2010

(54) Fishing lure carrier

(76) Inventor: Evan M. Debono, Levittown, NY (US)

Correspondence Address: LITMAN LAW OFFICES, LTD., POST OFFICE BOX 15035, CRYSTAL CITY STATION, ARLINGTON, VA, 22215, US

(21) Appl. No.: 12/662,243

(22) Filed: Apr. 7, 2010

Related U.S. Application Data
(60) Provisional application No. 61/202,823, filed on Apr. 8, 2009.

(51) Int. Cl. A01K 97/06

(52) U.S. Cl. 43/54.1

(57) ABSTRACT

The fishing lure carrier includes a substantially cylindrical housing for storing lures, the housing having a perforated bottom for drainage and an open top; a removable cap for selective covering of the open top; and a belt clip formed on an exterior surface of the housing for selective attachment to the user's belt. The cap is retained on the cylindrical housing by a tether.

### CROSS-REFERENCE TO RELATED APPLICATION

This application claims the benefit of U.S. Provisional Patent Application Ser. No. 61/202,823, filed Apr. 8, 2009.

### FIELD OF THE INVENTION

The present invention relates to fishing aids, and more particularly to a fishing lure carrier for convenient storage and toting of fishing lures.

### DESCRIPTION OF THE RELATED ART

Fishing has been a fundamental skill for survival and recreation in the history of mankind. It has evolved from using hands to using fishing poles and hooks. Currently, most people who fish do so for recreational purposes. This activity requires special equipment such as the ubiquitous fishing rod or pole, extra fishing lines, hooks, lures and other accessories. For surf fishing, a traditional over-the-shoulder bag has been used to store all the fishing hardware. However, certain problems arise from using the bag. One of the problems is the tendency of the bag moving around the body when casting the fishing pole due to the momentum from the casting action. This results in interfering with the cast. The natural tendency of bag movement whenever the user bends or moves also interferes with retrieval of the lure. Another problem is the numerous instances of the lure snagging on the bag material whenever the lure is taken out of the bag. Thus, it would be beneficial in the art to have a container that can store lures and easily carried without potential interference with the fishing activity in addition to snag free retrieval of the lure.

Thus, a fishing lure carrier solving the aforementioned problems is desired.

### SUMMARY OF THE INVENTION

The fishing lure carrier includes a substantially cylindrical housing for storing lures, the housing having a perforated bottom for drainage and an open top; a removable cap for selective covering of the open top; and a belt clip formed on an exterior surface of the housing for selective attachment to the user's belt.

These and other features of the present invention will become readily apparent upon further review of the following specification and drawings.

### BRIEF DESCRIPTION OF THE DRAWINGS

FIG. 1 is an environmental, perspective view of a fishing lure carrier according to the present invention.

FIG. 2 is a perspective view of the fishing lure carrier according to the present invention.

FIG. 3 is a top view of the fishing lure carrier according to the present invention.

Similar reference characters denote corresponding features consistently throughout the attached drawings.

### DETAILED DESCRIPTION OF THE PREFERRED EMBODIMENTS

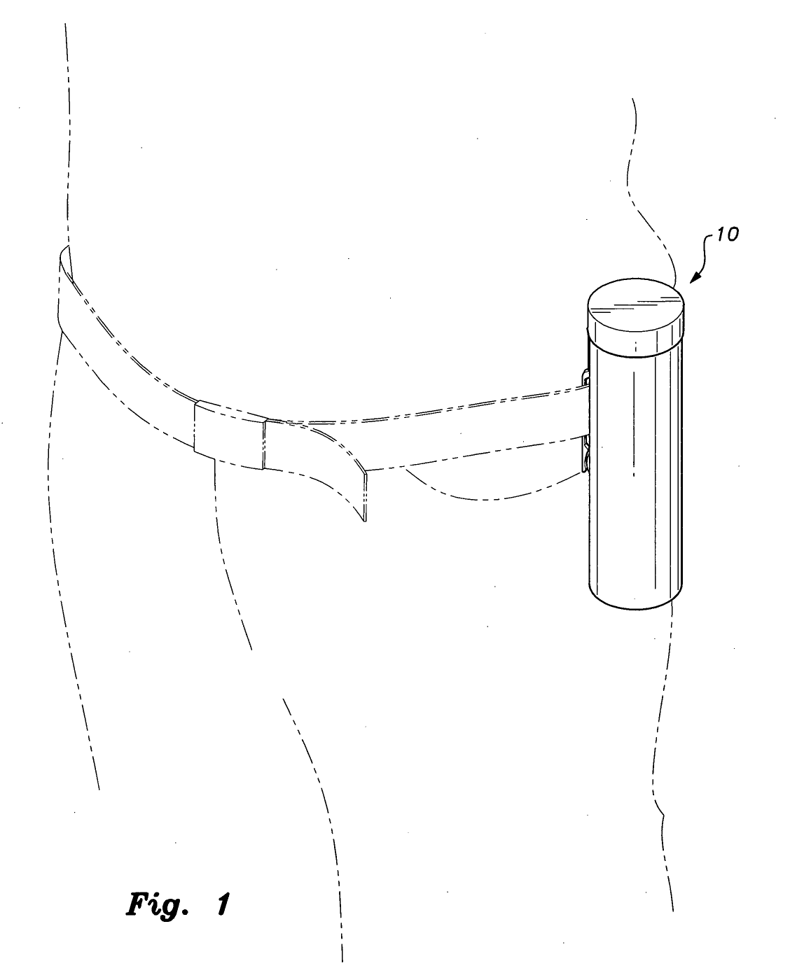

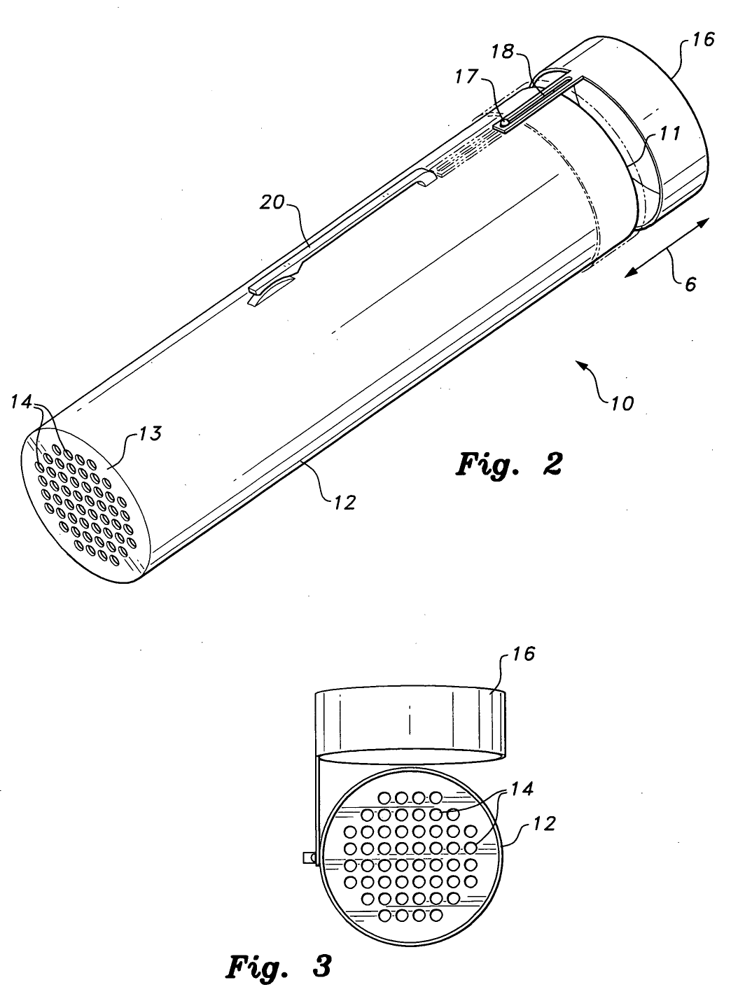

The fishing lure carrier is configured for easy portability and hassle-free use of the lure therein. As shown in FIGS. 1-3, the fishing lure carrier 10 includes a substantially cylindrical body or container 12 having a closed perforated bottom 13 at one end and an opposite open top end 11. The body 12 functions as a container to store lure(s) used by a fisherman, and it is preferably made from durable plastic. It may also be translucent or transparent so that the fisherman may easily see the lure contained therein. The perforated bottom 13 includes a plurality of perforations 14, which serve to allow drainage of and/or drying of the lure inside the container 12.

The fishing lure carrier 10 also includes a removable cover or cap 16 configured to fit over the open end 11. The cap 16 seals the stored lure and prevents the lure from inadvertently sliding out of the container 12 during transport. The cap 16 includes an integral, elongated tether 18 extending from the rim on the open side of the cap 16. The tether 18 has an elongated slot formed therein adapted to be detachably mounted to a protruding mushroom pin 17 formed on the exterior surface of the container 12. The tether anchors the cap 16 to the container body 12 vis-à-vis the pin 17, and the elongated slot allows the cap 16 to be selectively removed from the open end 11, as indicated by the arrows 6, as well as to facilitate swiveling of the cap 16 about the pin 17 so that the user may gain access to the interior of the container 12, as shown in FIG. 3.

For easy transport, the fishing lure carrier 10 includes a belt clip 20 disposed on the exterior surface of the container 12 so that the user may mount the carrier on his/her belt. The belt clip 20 may be a fixed configuration or an adjustable configuration, the adjustable configuration allowing the user to rotate the container 12 with respect to the belt clip 20 to a more comfortable and/or more lure accessible position.

The following describes how the fishing lure carrier 10 is used. In preparation for fishing, the user removes the cap 16 from the open end 11 to uncover the container 12 and swivels the cap 16 to gain access to the interior of the container 12. A fishing lure is dropped inside the container 12 and the cap 16 seals the container 12. The user clips the fishing lure carrier 10 onto his/her belt for easy transport to a favorite fishing spot. To retrieve the lure, the user repeats the cap removal process without fear of snagging the lure on the container 12. It is noted that the user may simultaneously utilize a plurality of fishing lure carriers 10. When it is desired to clean the fishing lure carrier 10 and/or the lure, the user may dip the fishing lure carrier 10 in or flushed with fresh water or cleaning solution. The excess water or cleaning solution is drained through the perforations 14.

It is noted that the fishing lure carrier 10 may encompass a variety of alternatives to the various features thereof. Although it has been mentioned that the fishing lure carrier 10 may be made from plastic, other types of materials such as wood, steel or water-resistant or waterproof fabrics that can retain the desired shape of the container 12 may also be used to make the fishing lure carrier 10. The fishing lure carrier 10 may also come in a variety of shapes. In addition, the fishing lure carrier 10 may include a variety of colors to, e.g., differentiate the variety of lures contained therein. Moreover, indicia may be included on the top of the cover 16 and/or the surface of the container 12 to indicate various lures, personalize the carrier 10 and/or brand name marking.

Thus, it can be seen that the fishing lure carrier 10 is a lightweight, convenient portable system for storing and transporting fishing lures. The relatively small form factor allows the user carry a plurality of fishing lure carriers 10 in relative comfort, and the configuration of the fishing lure carrier 10 reduces or eliminates the aforementioned interfering impact on the fishing experience.

It is to be understood that the present invention is not limited to the embodiments described above, but encompasses any and all embodiments within the scope of the following claims.

I claim:

1. A fishing lure carrier, comprising:
a container body having a flat, perforated bottom and an open top, the container body being adapted to store a fishing lure therein;
a selectively removable cap having a tether anchoring the cap to the container body; and
a belt clip attached to the container body for selective mounting on a user's belt.

2. The fishing lure carrier according to claim 1, further comprising a mushroom pin protruding from the container body, the tether being elongated and having an elongated slot mounted over the mushroom pin, the tether permitting selective covering of the container body and pivoting of the cap to gain access to the container body.

3. The fishing lure carrier according to claim 1, wherein said container body comprises a substantially cylindrical tube having the perforated bottom at one end of the tube and the open top at an opposite end of the tube.

4. The fishing lure carrier according to claim 1, wherein said container body includes indicia on a side thereof.

5. The fishing lure carrier according to claim 1, wherein said cap includes a closed top, the closed top having indicia thereon.

6. The fishing lure carrier according to claim 1, wherein said cap includes a closed top, both said container body and the closed top having indicia disposed thereon.

7. A fishing lure carrier, comprising:
a container body having a flat, perforated bottom and an open top, the container body being adapted to store a fishing lure therein;
a selectively removable cap covering the open top of the container body;
means for retaining the cap connected to the container body when the cap is removed from the top of the container; and
a belt clip attached to the container body for selective mounting on a user's belt.

8. The fishing lure carrier according to claim 7, wherein said means for retaining the cap comprises:
a mushroom pin protruding from said container body, the mushroom pin having a head; and
an elongated tether having a first end fixed to said cap and a second end having an elongated slot defined therein, the slot being flexibly mounted over the mushroom pin, the head retaining the second end on the pin.

9. The fishing lure carrier according to claim 7, wherein said container body comprises a substantially cylindrical tube having the perforated bottom at one end of the tube and the open top at an opposite end of the tube.

10. A fishing lure carrier, comprising:
a container body having a flat, perforated bottom and an open top, the container body being adapted to store a fishing lure therein;
a selectively removable cap having a tether anchoring the cap to the container body; and
means for selectively attaching the container body to a user's belt.

11. The fishing lure carrier according to claim 10, further comprising a mushroom pin protruding from the container body, the tether being elongated and having an elongated slot mounted over the mushroom pin, the tether permitting selective covering of the container body and pivoting of the cap to gain access to the container body.

12. The fishing lure carrier according to claim 10, wherein said container body comprises a substantially cylindrical tube having the perforated bottom at one end of the tube and the open top at an opposite end of the tube.

13. The fishing lure carrier according to claim 10, wherein said means for selectively attaching the container body comprises a belt clip attached to the container body.
